(19) United States
(12) Patent Application Publication
(10) Pub. No.: US 2007/0061152 A1
(43) Pub. Date: Mar. 15, 2007

(54) Apparatus and method for translating speech and performing speech synthesis of translation result

(75) Inventor: Miwako Doi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/384,391

(22) Filed: Mar. 21, 2006

(30) Foreign Application Priority Data
Sep. 15, 2005 (JP) 2005-269057

(51) Int. Cl. G10L 21/00

(52) U.S. Cl. 704/277

(57) ABSTRACT

A speech dialogue translation apparatus includes a speech recognition unit that recognizes a user's speech in a source language to be translated and outputs a recognition result; a source language storage unit that stores the recognition result; a translation decision unit that determines whether the recognition result stored in the source language storage unit is to be translated, based on a rule defining whether a part of an ongoing speech is to be translated; a translation unit that converts the recognition result into a translation described in an object language and outputs the translation, upon determination that the recognition result is to be translated; and a speech synthesizer that synthesizes the translation into a speech in the object language.

### CROSS-REFERENCE TO RELATED APPLICATIONS

This application is based upon and claims the benefit of priority from the prior Japanese Patent Application No. 2005-269057, filed on Sep. 15, 2005; the entire contents of which are incorporated herein by reference.

### BACKGROUND OF THE INVENTION

1. Field of the Invention

This invention relates to an apparatus, a method, and a computer program product for translating speech and performing speech synthesis of the translation result.

2. Description of the Related Art

In recent years, baby boomers who have reached the retirement age have begun to visit foreign countries in great numbers for purposes of sightseeing and technical assistance, and as a technique for aiding them in communication, the machine translation has come to be widely known. The machine translation is used also for the service of translating and displaying in Japanese the Web page retrieved by internet or the like which is written in a foreign language. The machine translation technique, in which the basic practice is to translate one sentence at a time, is useful for translating what is called written words such as a Web page or a technical operation manual.

The translation machine used for overseas travel or the like, on the other hand, requires a small size and portability. In view of this, a portable translation machine using the corpus-based machine translation technique is commercially available. In such a product, a corpus is constructed by using a collection of travel conversation examples or the like. Many sentences contained in the collection of travel conversation examples are longer than the sentences used in ordinary dialogues. When the portable translation machine constructing a corpus from a collection of travel conversation examples is used, therefore, the translation accuracy may be reduced unless a correct sentence ending with a period is spoken. To prevent the reduction in translation accuracy, the user is forced to speak a correct sentence, thereby deteriorating the operability.

With the method of inputting sentences directly using the pen, button or keyboard, it is difficult to reduce the device size. This method, therefore, is not suitable for the portable translation machine. In view of this, an application of the speech recognition technique for inputting sentences by recognizing the speech input through a microphone or the like is expected to be promising. The speech recognition, however, has the disadvantage that the recognition accuracy is deteriorated in an environment not low in noise unless a head set or the like is used.

Hori and Tsukata, “Speech Recognition with Weighted Finite State Transducer,” Information Processing Society of Japan Journal ‘Information Processing,’ Vol. 45, No. 10, pp. 1020-1026 (2004) (hereinafter, “Hori etc.”) proposes an extensive, high-speed speech recognition technique for aurally recognizing the speech input sequentially and replacing them with written words using a weighted finite state transducer and thereby recognizing the speech without reducing the recognition accuracy.

Generally, even in the case where the conditions for speech recognition are satisfied with a head set or the like and the algorithm is improved for speech recognition as described in Hori etc., a recognition error in speech recognition cannot be totally eliminated. In an application of the speech recognition technique to a portable translation machine, therefore, the erroneously recognized portion must be corrected before executing the machine translation to prevent the deterioration of the machine translation accuracy due to the recognition error.

The conventional machine translation assumes that a sentence is input in its entirety, and therefore, the problem is that the translation and speech synthesis are not carried out before complete input, with the result that the silence period lasts long and the dialogue cannot be conducted smoothly.

Also, in the case where a recognition error occurs, the correction is required by returning to the erroneously recognized portion of the whole sentence displayed on the display screen after inputting the whole sentence, thereby complicating the operation. Even the method of Hori etc. in which the speech recognition result is sequentially output poses a similar problem in view of the fact that the machine translation and speech synthesis are carried out normally after the whole sentence is aurally recognized and output.

Also, during correction, the silence prevails and the line of sight of the user is not directed to the other party of dialogue but concentrated on the display screen of the portable translation machine. This poses the problem that the smooth dialogue is adversely affected greatly.

### SUMMARY OF THE INVENTION

According to one aspect of the present invention, a speech dialogue translation apparatus includes a speech recognition unit that recognizes a user's speech in a source language to be translated and outputs a recognition result; a source language storage unit that stores the recognition result; a translation decision unit that determines whether the recognition result stored in the source language storage unit is to be translated, based on a rule defining whether a part of an ongoing speech is to be translated; a translation unit that converts the recognition result into a translation described in an object language and outputs the translation, upon determination that the recognition result is to be translated; and a speech synthesizer that synthesizes the translation into a speech in the object language.

According to another aspect of the present invention, a speech dialogue translation method includes recognizing a user's speech in a source language to be translated; outputting a recognition result; determining whether the recognition result stored in a source language storage unit is to be translated, based on a rule defining whether a part of an ongoing speech is to be translated; converting the recognition result into a translation described in an object language and outputs the translation, upon determination that the recognition result is to be translated; and synthesizing the translation into a speech in the object language.

A computer program product according to still another aspect of the present invention causes a computer to perform the method according to the present invention.

### BRIEF DESCRIPTION OF THE DRAWINGS

FIG. 1 is a block diagram showing a configuration of the speech dialogue translation apparatus according to a first embodiment;

FIG. 2 is a diagram for explaining an example of the data structure of a source language storage unit;

FIG. 3 is a diagram for explaining an example of the data structure of a translation decision rule storage unit;

FIG. 4 is a diagram for explaining an example of the data structure of a translation storage unit;

FIG. 5 is a flowchart showing the general flow of the speech dialogue translation process according to the first embodiment;

FIG. 6 is a diagram for explaining an example of the data processed in the conventional speech dialogue translation apparatus;

FIG. 7 is a diagram for explaining another example of the data processed in the conventional speech dialogue translation apparatus;

FIG. 8 is a diagram for explaining a specific example of the speech dialogue translation process in the speech dialogue translation apparatus according to the first embodiment;

FIG. 9 is a diagram for explaining a specific example of the speech dialogue translation process executed upon occurrence of a speech recognition error;

FIG. 10 is a diagram for explaining a specific example of the speech dialogue translation process executed upon occurrence of a speech recognition error;

FIG. 11 is a diagram for explaining another specific example of the speech dialogue translation process executed upon occurrence of a speech recognition error;

FIG. 12 is a diagram for explaining still another specific example of the speech dialogue translation process executed upon occurrence of a speech recognition error;

FIG. 13 is a block diagram showing a configuration of the speech dialogue translation apparatus according to a second embodiment;

FIG. 14 is a block diagram showing the detailed configuration of an image recognition unit;

FIG. 15 is a diagram for explaining an example of the data structure of the translation decision rule storage unit;

FIG. 16 is a diagram for explaining another example of the data structure of the translation decision rule storage unit;

FIG. 17 is a flowchart showing the general flow of the speech dialogue translation process according to a second embodiment;

FIG. 18 is a flowchart showing the general flow of the image recognition process according to the second embodiment;

FIG. 19 is a diagram for explaining an example of the information processed in the image recognition process;

FIG. 20 is a diagram for explaining an example of a normalized pattern;

FIG. 21 is a block diagram showing a configuration of the speech dialogue translation apparatus according to a third embodiment;

FIG. 22 is a diagram for explaining an example of operation detected by an acceleration sensor;

FIG. 23 is a diagram for explaining an example of the data structure of the translation decision rule storage unit; and

FIG. 24 is a flowchart showing the general flow of the speech dialogue translation process according to the third embodiment.

### DETAILED DESCRIPTION OF THE INVENTION

With reference to the accompanying drawings, a speech dialogue translation apparatus, a speech dialogue translation method and a speech dialogue translation program according to the best mode of carrying out the invention are explained in detail below.

In the speech dialogue translation apparatus according to a first embodiment, the input speech is aurally recognized and each time of determination that one phase is input, the recognition result is translated while at the same time performing speech synthesis and output of the translation constituting the result of translation.

In the description that follows, it is assumed that the translation process is executed with Japanese as the source language and English as the language to translate to (hereinafter referred to as the object language). Nevertheless, the combination of the source language and the object language is not limited to Japanese and English, and the invention is applicable to the combination of any languages.

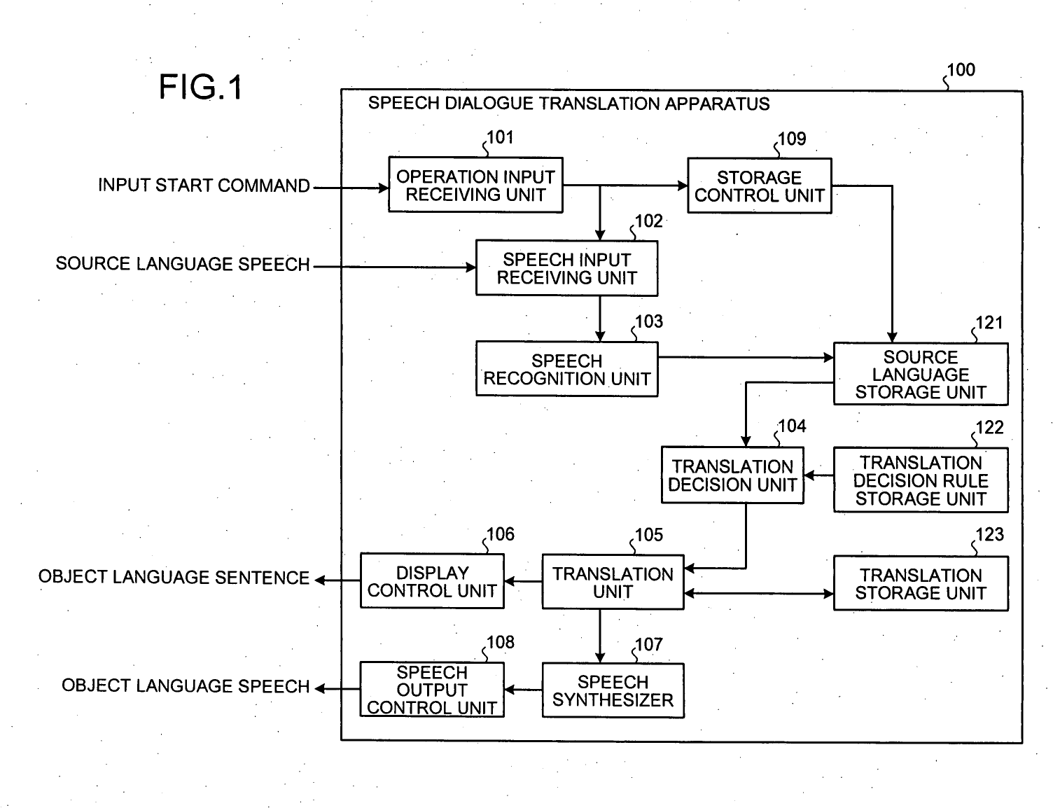

FIG. 1 is a block diagram showing a configuration of a speech dialogue translation apparatus 100 according to a first embodiment. As shown in FIG. 1, the speech dialogue translation apparatus 100 comprises an operation input receiving unit 101, a speech input receiving unit 102, a speech recognition unit 103, a translation decision unit 104, a translation unit 105, a display control unit 106, a speech synthesizer 107, a speech output control unit 108, a storage control unit 109, a source language storage unit 121, a translation decision rule storage unit 122 and a translation storage unit 123.

The operation input receiving unit 101 receives the operation input from an operating unit (not shown) such as a button. For example, an operation input such as a speech input start command from the user to start the speech or a speech input end command from the user to end the speech is received.

The speech input receiving unit 102 receives the speech input from a speech input unit (not shown) such as a microphone to input the speech in the source language spoken by the user.

The speech recognition unit 103, after receiving the speech input start command by the operation input receiving unit 101, executes the process of recognizing the input speech received by the speech input receiving unit 102 and outputs the recognition result. The speech recognition process executed by the speech recognition unit 103 can use any of the generally used speech recognition methods including LPC analysis, Hidden Markov Model (HMM), dynamic programming, neural network and N gram language model.

According to the first embodiment, the speech recognition process and the translation process are sequentially executed with a phrase or the like less than one sentence as a unit, and therefore the speech recognition unit 103 uses a high-speed speech recognition method such as described in Hori etc.

The translation decision unit 104 analyzes the result of the speech recognition, and referring to the rule stored in the translation decision rule storage unit 122, determines whether the recognition result is to be translated or not. According to the first embodiment, a predetermined language unit such as a word or a phrase constituting a sentence is defined as an input unit and it is determined whether the speech recognition result corresponds to the predetermined language unit or not. When the source language of a language unit is input, the translation rule defined in the translation decision rule storage unit 122 corresponding to the particular language unit is acquired, and the execution of the translation process is determined in accordance with the particular method.

When the recognition result is analyzed and the language unit such as a word or a phrase is extracted, all the conventionally used techniques for natural language analysis process such as morphemic analysis and parsing can be used.

As a translation rule, the partial translation for executing the translation process on the recognition result of the input language unit or the total translation for translating the whole sentence as a unit can be designated. Also, a rule may be laid down that all the speech thus far input are deleted and the input is repeated without executing the translation. The translation rule is not limited to them, but any rule specifying the process executed for translation by the translation unit 105 can be defined.

Also, the translation decision unit 104 determines whether the speech of the user has ended or not by referring to the operation input received by the operation input receiving unit 101. Specifically, the operation input receiving unit 101, upon receipt of the input end command from the user, determines that the speech has ended. Upon determination that the speech has ended, the translation decision unit 104 determines the execution of the total translation by which all the recognition result input from the speech input start to the speech input end are translated.

The translation unit 105 translates the source language sentence in Japanese into the object language sentence, i.e. English. The translation process executed by the translation unit 105 can use any of all the methods used in the machine translation system including the ordinary transfer scheme, example base scheme, statistical base scheme and intermediate language scheme.

The translation unit 105, upon determination of execution of the partial translation by the translation decision unit 104, acquires the latest recognition result not translated, from the recognition result stored in the source language storage unit 121, and executes the translation process on the recognition result thus acquired. When the translation decision unit 104 determines the execution of the total translation, on the other hand, the translation process is executed on the sentence configured of all the recognition results stored in the source language storage unit 121.

When the translation is concentrated on the phrase for partial translation, the translation failing to conform to the context of the phrase translated in the past may be executed. Therefore, the result of semantic analysis in the past translation may be stored in a storage unit (not shown), and referred to when translating a new phrase thereby to assure translation of higher accuracy.

The display control unit 106 displays the recognition result by the speech recognition unit 103 and the result of translation by the translation unit 105 on a display unit (not shown).

In the speech synthesizer 107, the translation output from the translation unit 105 is output as a synthesized English speech constituting the object language. This speech synthesis process can use any of all the generally used methods including the text-to-speech system employing the phonemes compiling speech synthesis or Formant speech synthesis.

The speech output control unit 108 controls the process executed by the speech output unit (not shown) such as the speaker to output the synthesized speech from the speech synthesizer 107.

The storage control unit 109 executes the process of deleting the source language and the translation stored in the source language storage unit 121 and the translation storage unit 123 in response to a command from the operation input receiving unit 101.

The source language storage unit 121 stores the source language which is the result of recognition output from the speech recognition unit 103 and can be configured of any of generally used storage media such as HDD, optical disk and memory card.

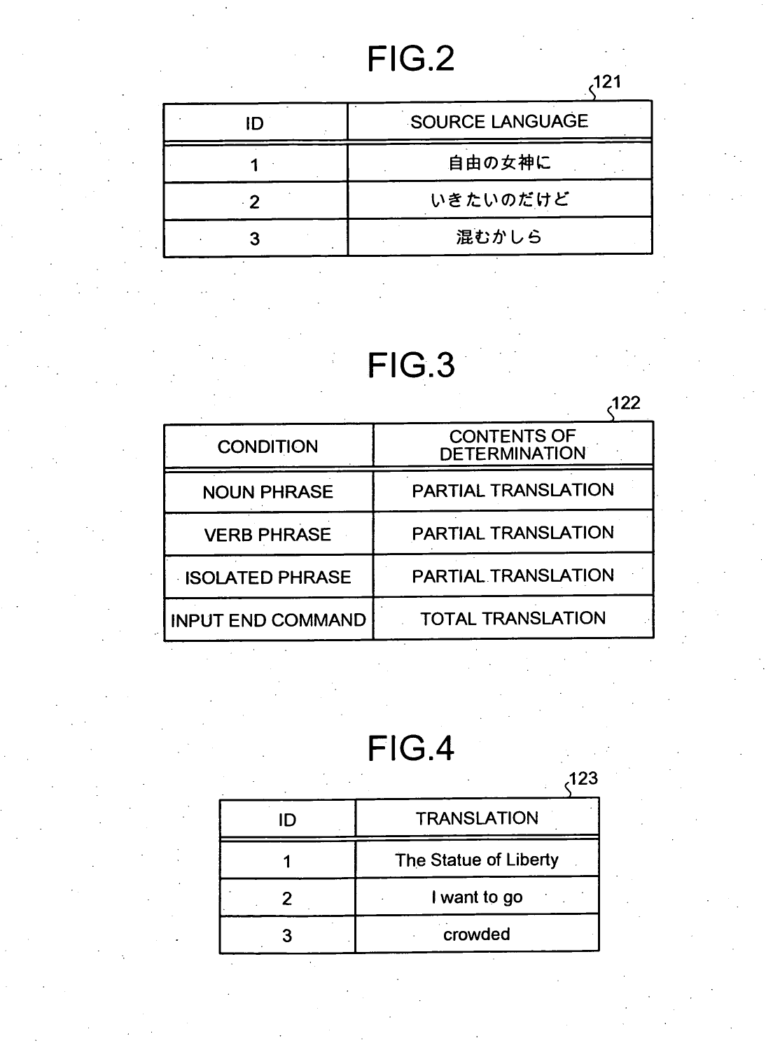

FIG. 2 is a diagram for explaining an example of the data structure of the source language storage unit 121. As shown in FIG. 2, the source language storage unit 121 stores the ID for uniquely identifying the source language and the source language forming the result of recognition output from the speech recognition unit 103 as corresponding data. The source language storage unit 121 is accessed by the translation unit 105 for executing the translation process and by the storage control unit 109 deleting the recognition result.

The translation decision rule storage unit 122 stores the rule referred to when the translation decision unit 104 determines whether the recognition result should be translated or not, and can be configured of any of the generally used storage media such as HDD, optical disk and memory card.

FIG. 3 is a diagram for explaining an example of the data structure of the translation decision rule storage unit 122. As shown in FIG. 3, the translation decision rule storage unit 122 stores the conditions providing criteria and the corresponding contents of determination. The translation decision rule storage unit 122 is accessed by the translation decision unit 104 to determine whether the recognition result to be translated, and if to be translated, whether it is partially or totally translated or not.

In the shown case, the phrase type is classified into the noun phrase, verb phase, isolated phrase (such phrases as calls and dates and hours other than the noun phrase and verb phrase), and the rule is laid down to the effect that each phrase, if input, is to be partially translated. Also, the rule is set that in the case where the operation input receiving unit 101 receives the input end command, the total translation is performed.

The translation storage unit 123 is for storing the translation output from the translation unit 105, and can be configured of any of the generally used storage media including the HDD, optical disk and memory card.

FIG. 4 is a diagram for explaining an example of the data structure of the translation storage unit 123. As shown in FIG. 4, the translation storage unit 123 has stored therein an ID for identifying the translation uniquely and the corresponding translation output from the translation unit 105.

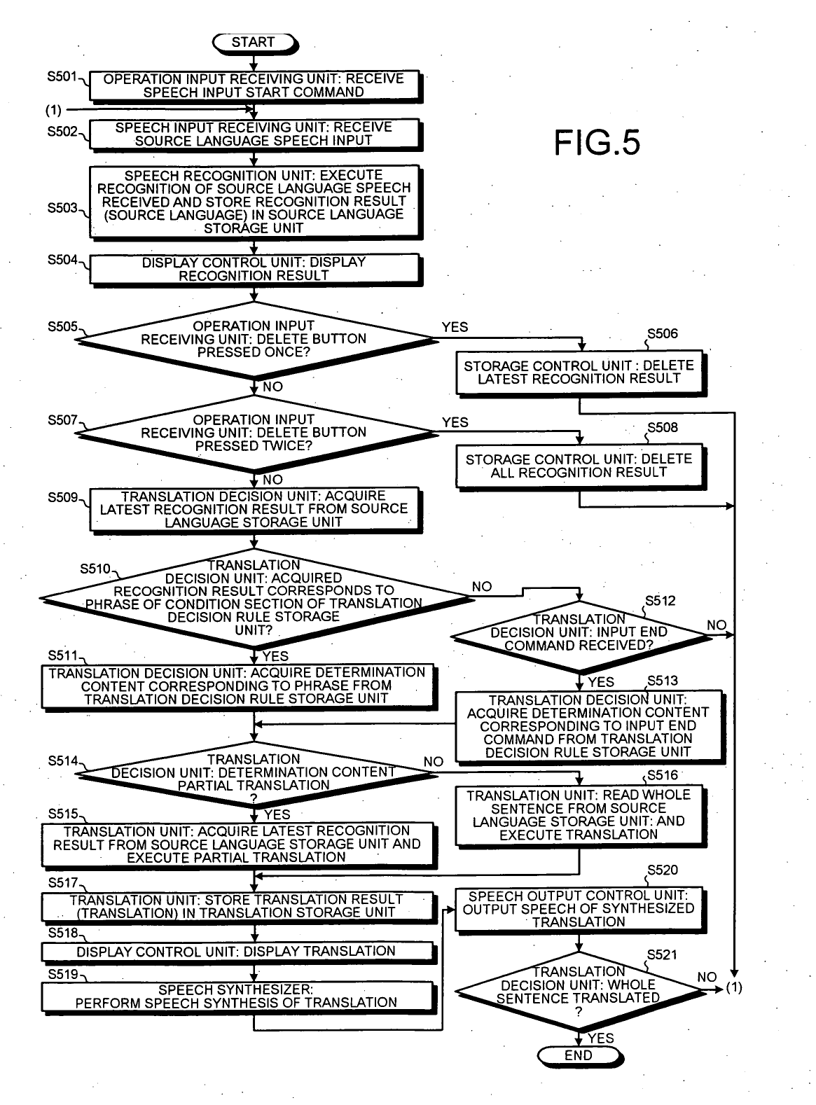

Next, the speech dialogue translation process executed by the speech dialogue translation apparatus 100 according to the first embodiment configured as described above is explained. FIG. 5 is a flowchart showing the general flow of the speech dialogue translation process according to the first embodiment. The speech dialogue translation process is defined as a process including the step of the user speaking one sentence to the step of speech synthesis and output of the particular sentence.

First, the operation input receiving unit 101 receives the speech input start command input by the user (step S501). Next, the speech input receiving unit 102 receives the speech input in the source language spoken by the user (step S502).

Then, the speech recognition unit 103 executes the recognition of the speech in the source language received, and stores the recognition result in the source language storage unit 121 (step S503). The speech recognition unit 103 outputs the recognition result by sequentially executing the speech recognition process before completion of the entire speech of the user.

Next, the display control unit 106 displays the recognition result output from the speech recognition unit 103 on the display screen (step S504). A configuration example of the display screen is described later.

Next, the operation input receiving unit 101 determines whether the delete button has been pressed once by the user or not (step S505). When the delete button is pressed once (YES at step S505), the storage control unit 109 deletes the latest recognition result stored in the source language storage unit 121 (step S506), and the process returns to and repeats the speech input receiving process (step S502). The latest recognition result is defined as the result of speech recognition during the period from the speech input start to the end and stored in the source language storage unit 121 but not subjected to the translation process by the translation unit 105.

Upon determination at step S505 that the delete button is not pressed once (NO at step S505), the operation input receiving unit 101 determines whether the delete button has been pressed twice successively (step S507). When the delete button is pressed twice successively (YES at step S507), the storage control unit 109 deletes all the recognition result stored in the source language storage unit 121 (step S508), and the process returns to the speech input receiving process.

When the delete button has been pressed twice successively, therefore, the entire speech thus far input is deleted and the input can be repeated from the beginning. As an alternative, the recognition result may be deleted sequentially on last-come-first-served basis each time the delete button is pressed.

Upon determination at step S507 that the delete button is not pressed twice successively (NO at step S507), on the other hand, the translation decision unit 104 acquires the recognition result not translated from the source language storage unit 121 (step S509).

Next, the translation decision unit 104 determines whether the acquired recognition result corresponds to the phrase described in the condition section of the translation decision rule storage unit 122 or not (step S510). When the answer is affirmative (YES at step S510), the translation decision unit 104 accesses the translation decision rule storage unit 122 and acquires the contents of determination corresponding to the particular phrase (step S511). When the rule as shown in FIG. 3 is stored in the translation decision rule storage unit 122 and the acquired recognition result is a noun phrase, for example, the “partial translation” is acquired as the contents of determination.

Upon determination at step S510 that the acquired recognition result fails to correspond to the phrase in the condition section (NO at step S510), on the other hand, the translation decision unit 104 determines whether the input end command has been received from the operation input receiving unit 101 or not (step S512).

When the input end command is not received (NO at step S512), the process returns to the speech input receiving process and the whole process is restarted (step S502). When the input end command is received (YES at step S512), the translation decision unit 104 accesses the translation decision rule storage unit 122 and acquires the contents of determination corresponding to the input end command (step S513). When the rule shown in FIG. 3 is stored in the translation decision rule storage unit 122, for example, the “total translation” is acquired as the contents of determination corresponding to the input end command.

After acquiring the contents of determination at step S511 or S513, the translation decision unit 104 determines whether the contents of determination are the partial translation or not (step S514). When the partial translation is involved (YES at step S514), the translation unit 105 acquires the latest recognition result from the source language storage unit 121 and executes the partial translation of the acquired recognition result (step S515).

When the partial translation is not involved, i.e. in the case where the total translation is involved (NO at step S514), on the other hand, the translation unit 105 reads the entire recognition result from the source language storage unit 121 and executes the total translation with the entire read recognition result as one unit (step S516).

Next, the translation unit 105 stores the translation (translated words) constituting the translation result in the translation storage unit 123 (step S517). Next, the display control unit 106 displays the translation output from the translation unit 105 on the display screen (step S518).

Next, the speech synthesizer 107 performs speech synthesis and outputs the translation output from the translation unit 105 (step S519). Then, the speech output control unit 108 outputs the speech of the translation synthesized by the speech synthesizer 107 to the speaker or the like speech output unit (step S520).

The translation decision unit 104 determines whether the total translation has been executed or not (step S521), and in the case where the total translation is not executed (NO at step S521), the process returns to the speech input receiving process to repeat the process from the beginning (step S502). When the total translation is executed (YES at step S521), on the other hand, the speech dialogue translation process is finished.

Next, a specific example of the speech dialogue translation process in the speech dialogue translation apparatus 100 according to the first embodiment having the configuration described above is explained. First, a specific example of the speech dialogue translation process in the conventional dialogue translation apparatus is explained.

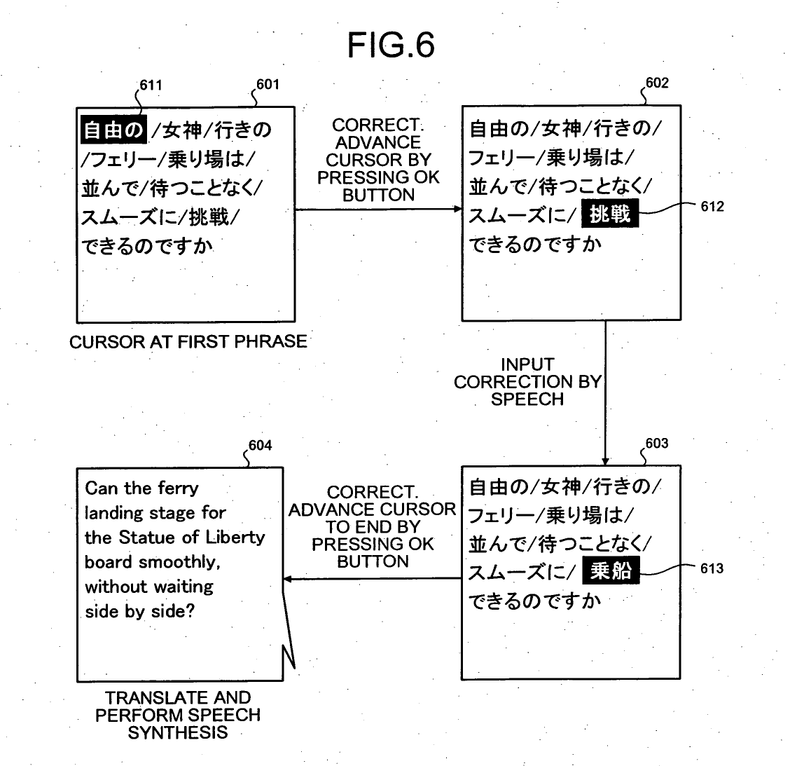

FIG. 6 is a diagram for explaining an example of the data processed in the conventional speech dialogue translation apparatus. In the conventional speech dialogue translation apparatus, the whole of one sentence is input and the user inputs the input end command, and then the speech recognition result of the whole sentence is displayed on the screen, phrase by phrase in writing with a space between words. The screen 601 shown in FIG. 6 is an example of the screen in such a state. Immediately after input end, the cursor 611 on the screen 601 is located at the first phrase. The phrase at which the cursor is located can be corrected by inputting the speech again.

When the first phrase is correctly aurally recognized, the OK button is pressed or otherwise the cursor is advanced to the next phrase. The screen 602 indicates the state in which the cursor 612 is located at an erroneously aurally recognized phrase.

Under this condition, the correction is input aurally. As shown on the screen 603, the phrase indicated by the cursor 613 is replaced by the result recognized again. When the result recognized again is correct, the OK button is pressed and the cursor is advanced to the end of the sentence. As shown on the screen 604, the result of the total translation is displayed and the translation result is aurally synthesized and output.

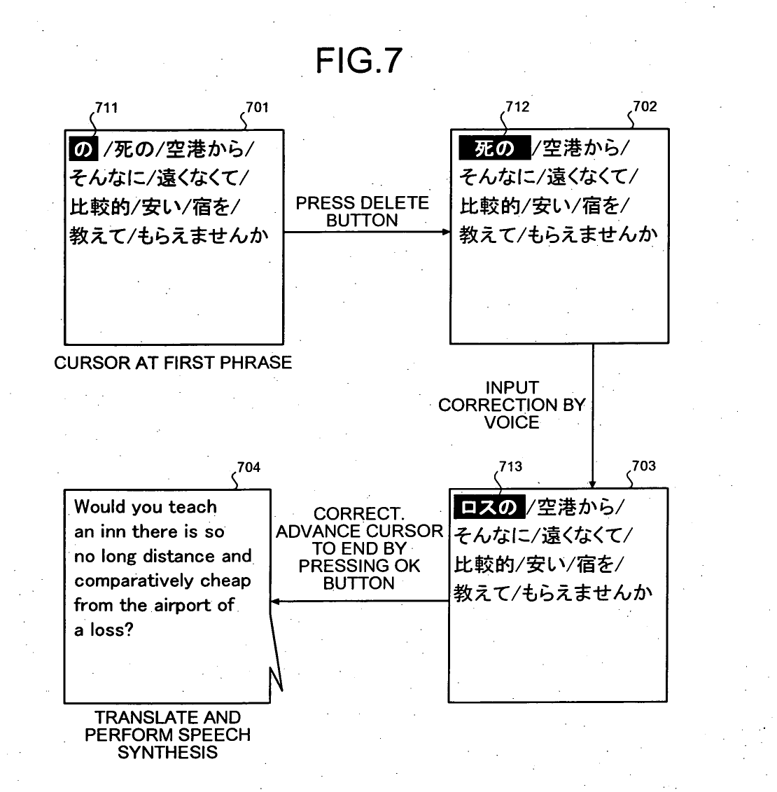

FIG. 7 is a diagram for explaining another example of the data processed in the conventional speech dialogue translation apparatus. In the example shown in FIG. 7, the unrequired phrase is displayed by the cursor 711 on the screen 701 due to a recognition error. The delete button is pressed to delete the phrase of the cursor 711, and the cursor 712 is located at the phrase to be corrected as shown on the screen 702.

Under this condition, the aural correction is input. As shown on the screen 703, the phrase indicated by the cursor 713 is replaced with the result of the repeated recognition. When the result of the repeated recognition is correct, the OK button is pressed, and the cursor is advanced to the end of the sentence. Thus, the result of total translation is displayed as shown on the screen 704 while at the same time performing speech synthesis and output of the translation result.

As described above, in the conventional speech dialogue translation apparatus, the translation and speech synthesis are carried out after inputting the whole of one sentence, and therefore the silence period is lengthened making smooth dialogue impossible. Also, in the presence of an erroneous speech recognition, the operation of moving the cursor to the erroneous recognition point and performing the input operation again is complicated, thereby increasing the operation burden.

In the speech dialogue translation apparatus 100 according to the first embodiment, in contrast, the speech recognition result is displayed sequentially on the screen, and in the case of a recognition error, the input operation is repeated immediately for correction. Also, the recognition result is sequentially translated, aurally synthesized and output. Therefore, the silence period is reduced.

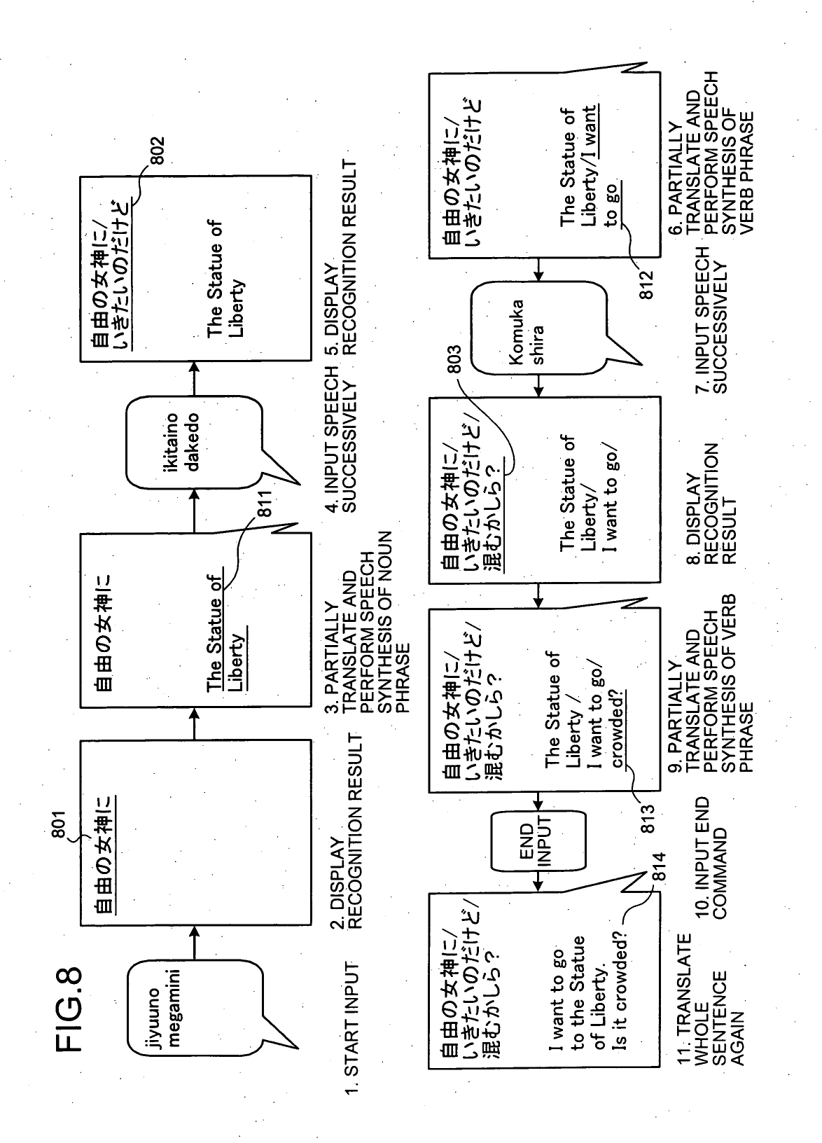

FIGS. 8 to 12 are diagrams for explaining a specific example of the speech dialogue translation process executed by the speech dialogue translation apparatus 100 according to the first embodiment.

As shown in FIG. 8, assume that the speech input by the user is started (step S501) and the speech “jiyuunomegamini” meaning “The Statue of Liberty” is aurally input (step S502). The speech recognition unit 103 aurally recognizes the input speech (step S503), and the resulting Japanese 801 is displayed on the screen (step S504).

The Japanese language 801 is a noun phrase, and therefore the translation decision unit 104 determines the execution of partial translation (steps S509 to S511), so that the translation unit 105 translates the Japanese 801 (step S515). The English 811 constituting the translation result is displayed on the screen (step S518), while the translation result is aurally synthesized and output (steps S519 to 520).

FIG. 8 shows an example, in which the user then inputs the speech “ikitainodakedo” meaning “I want to go.” In a similar process, the Japanese 802 and the English 812 as the translation result are displayed on the screen, and the English 812 is aurally synthesized and output. Also, in the case where the speech “komukashira” meaning “crowded” is input, the Japanese 803 and the English 813 constituting the translation result are displayed on the screen, and the English 813 is aurally synthesized and output.

Finally, the user inputs the input end command. Then, the translation decision unit 104 determines the execution of the total translation (step S512), and the total translation is executed by the translation unit 105 (step S516). As a result, the English 814 constituting the result of total translation is displayed on the screen (step S518). This embodiment represents an example in which the speech is aurally synthesized and output each time of sequential translation, to which the invention is not necessarily limited. For example, the speech may alternatively be synthesized and output only after total translation.

In the dialogue during the overseas travel, the perfect English is not generally spoken, but the intention of the speech is often understood by a mere arrangement of English words. In the speech dialogue translation apparatus 100 according to the first embodiment described above, the input Japanese are sequentially translated into English and output in an incomplete state before complete speech. Even this incomplete form of contents provides a sufficient aid in transmission of intention as a speech. Also, the entire sentence is translated again and output finally, and therefore the meaning of the speech can be positively transmitted.

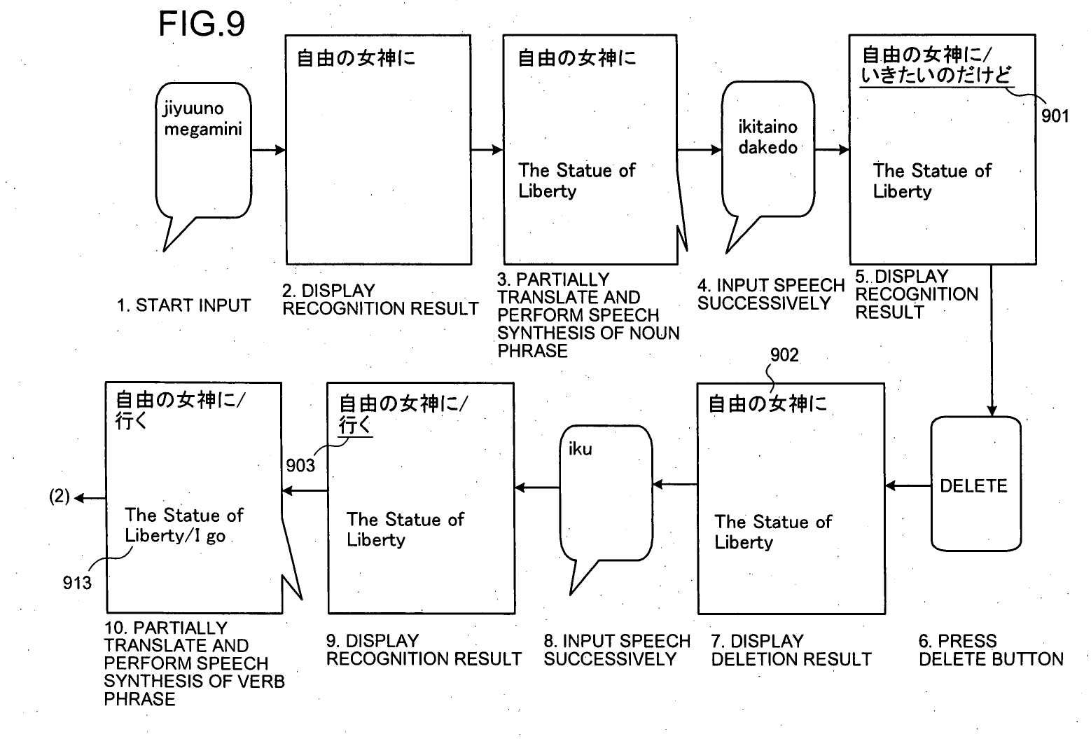

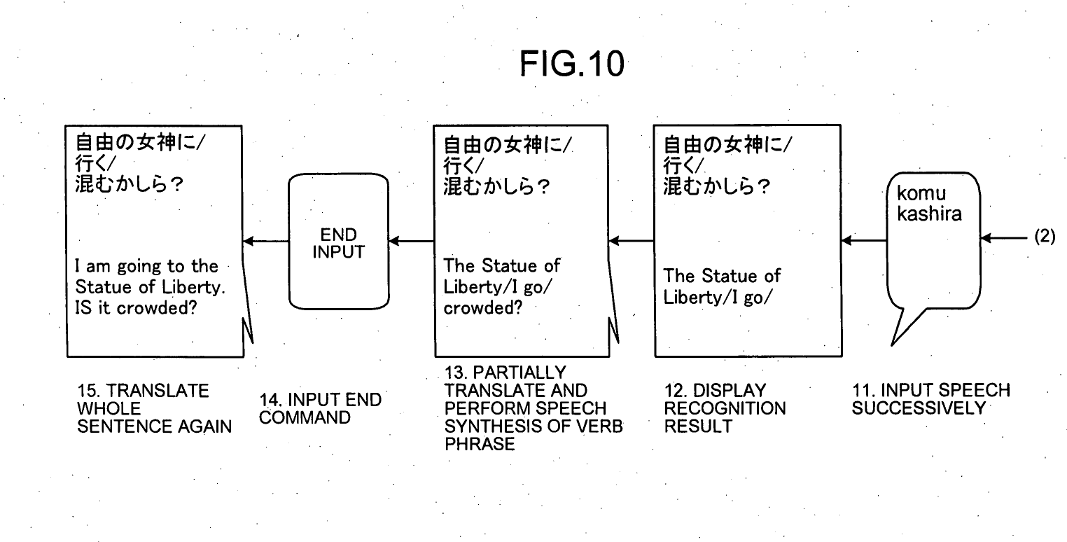

FIGS. 9 and 10 are diagrams for explaining a specific example of the speech dialogue translation process upon occurrence of a speech recognition error.

FIG. 9 illustrates a case in which a recognition error occurs at the second speech recognition session, and an erroneous Japanese 901 is displayed. In this case, the user confirms that the Japanese 901 on display is erroneous, and presses the delete button (step S505). In response, the storage control unit 109 deletes the Japanese 901 constituting the latest recognition result from the source language storage unit 121 (step S506), with the result that the Japanese 902 alone is displayed on the screen.

Then, the user inputs the speech “iku” meaning “go,” and the Japanese 903 constituting the recognition result and the English 913 constituting the translation result are displayed on the screen. The English 913 is aurally synthesized and output.

In this way, the latest recognition result is always confirmed on the screen and upon occurrence of a recognition error, the erroneously recognized portion can be easily corrected without moving the cursor.

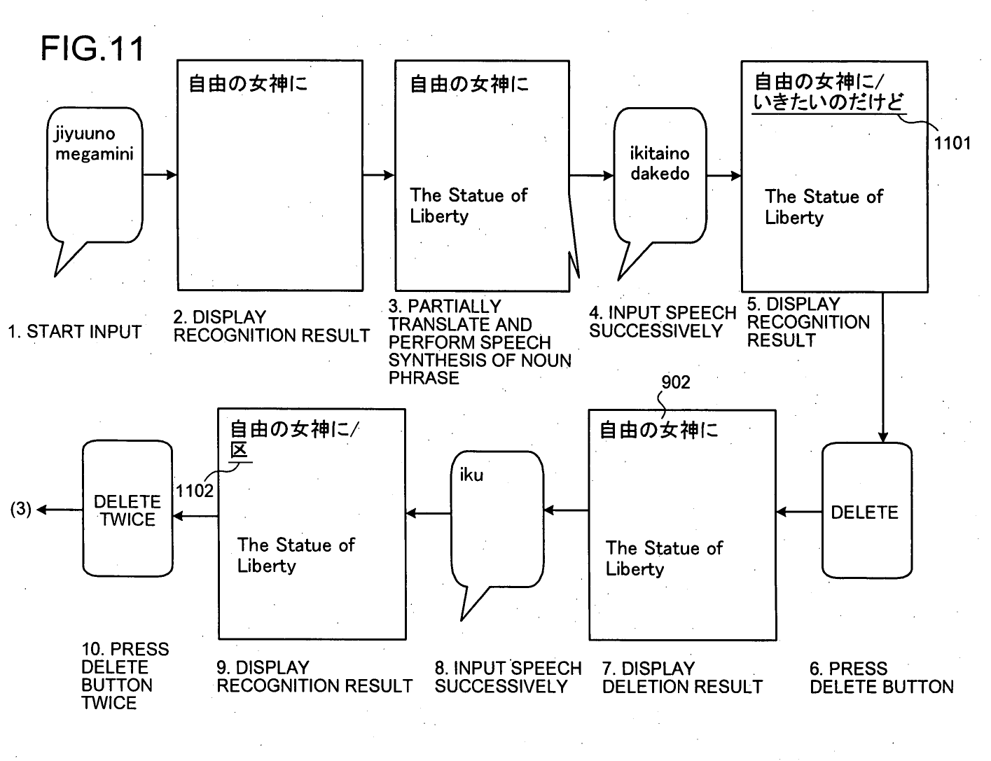

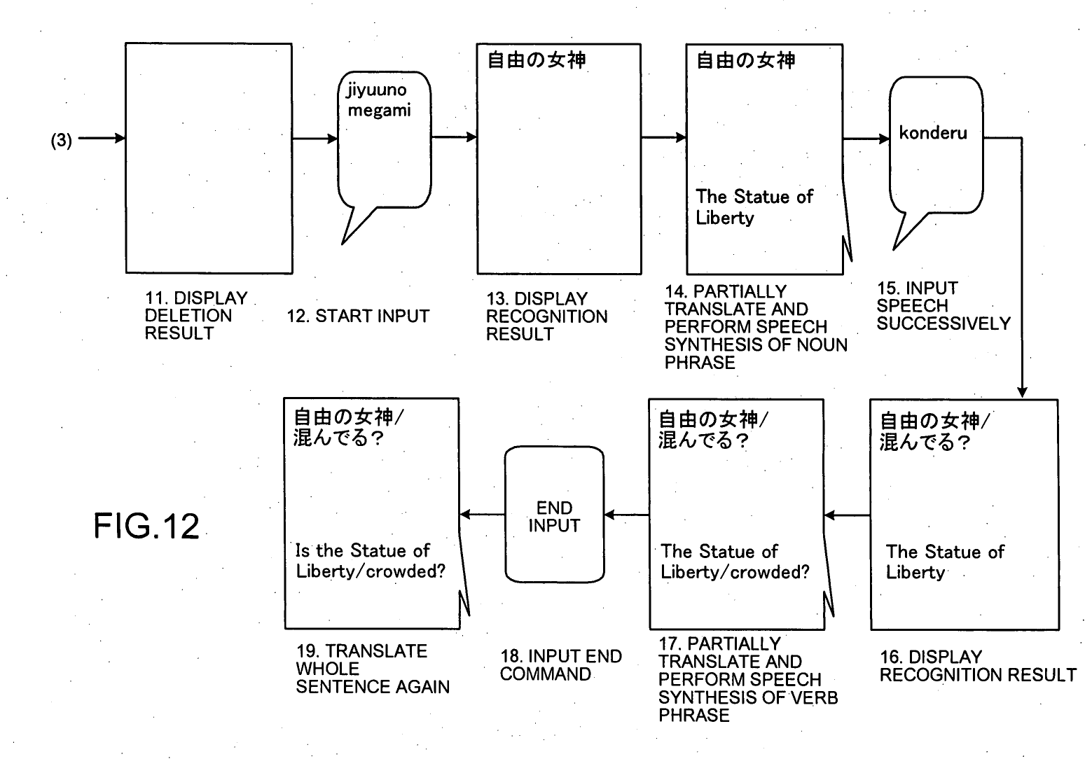

FIGS. 11 and 12 are diagrams for explaining another specific example of the speech dialogue translation process upon occurrence of a speech recognition error.

FIG. 11 shows an example in which, as in FIG. 9, a recognition error occurs in the second speech recognition session, and an erroneous Japanese 1101 is displayed. In the case of FIG. 11, the speech input again also develops a recognition error, and an erroneous Japanese 1102 is displayed.

Consider a case in which the user entirely deletes the input and restarts the speech from the beginning. In this case, the user presses the delete button twice in succession (step S507). In response, the storage control unit 109 deletes the entire recognition result stored in the source language storage unit 121 (step S508), and therefore as shown on the upper left portion of the screen, the entire display is deleted from the screen. In the subsequent repeated input process, the speech synthesis and output process are similar to the previous ones.

As described above, in the speech dialogue translation apparatus 100 according to the first embodiment, the input speech is aurally recognized, and each time of determination that one sentence is input, the recognition result is translated and the translation result is aurally synthesized and output. Therefore, the occurrence of silence time is reduced and a smooth dialogue can be promoted. Also, the operation burden for correction of the recognition error can be reduced. Therefore, the silence time due to the concentration on the correcting operation can be reduced, and a smooth dialogue is further promoted.

According to the first embodiment, the translation decision unit 104 determines, based on the linguistic knowledge, whether the translation is to be carried out or not. When a speech recognition error frequently occurs due to noises or the like, therefore, the linguistically correct information cannot be received and the normal translation decision may not be conducted. Therefore, a method of determining whether the translation should be carried out or not based on information other than the linguistic knowledge is effective.

According to the first embodiment, the English synthesized speech is output even during the speech in Japanese, and therefore the trouble may be caused by the superposition of speech between Japanese and English.

In the speech dialogue translation apparatus according to the second embodiment, the information from the image recognition unit for detecting the position and expression of the user face is referred to, and upon determination that the position or expression of the face of the user has changed, the recognition result is translated and the translation result is aurally synthesized and output.

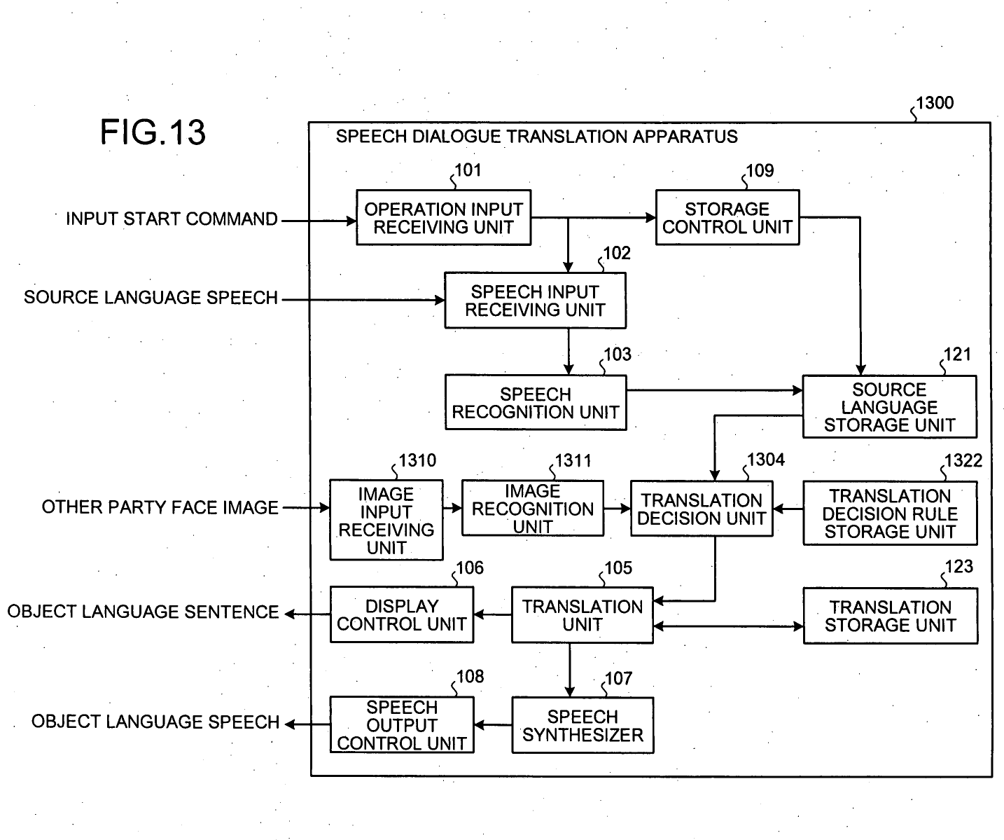

FIG. 13 is a block diagram showing a configuration of the speech dialogue translation apparatus 1300 according to the second embodiment. As shown in FIG. 13, the speech dialogue translation apparatus 1300 includes an operation input receiving unit 101, a speech input receiving unit 102, a speech recognition unit 103, a translation decision unit 1304, a translation unit 105, a display control unit 106, a speech synthesizer 107, a speech output control unit 108, a storage control unit 109, an image input receiving unit 1310, an image recognition unit 1311, a source language storage unit 121, a translation decision rule storage unit 1322 and a translation storage unit 123.

The second embodiment is different from the first embodiment in that the image input receiving unit 1310 and the image recognition unit 1311 are added, the translation decision unit 1304 has a different function and the contents of the translation decision rule storage unit 1322 are different. The other component parts of the configuration and functions, which are similar to those of the speech dialogue translation apparatus 100 according to the first embodiment shown in the block diagram of FIG. 1, are designated by the same reference numerals, respectively, and not described any more.

The image input receiving unit 1310 receives the image input from an image input unit (not shown) such as a camera for inputting the image of a human face. In recent years, the use of the portable terminal having the image input unit such as a camera-equipped mobile phone has spread, and the apparatus may be configured in such a manner that the image input unit attached to the portable terminal can be used.

The image recognition unit 1311 is for recognizing the face image of the user from the image (input image) received by the image input receiving unit 1310. FIG. 14 is a block diagram showing the detailed configuration of the image recognition unit 1311. As shown in FIG. 14, the image recognition unit 1311 includes a face area extraction unit 1401, a face parts detector 1402 and a feature data extraction unit 1403.

The face area extraction unit 1401 is for extracting the face area from the input image. The face parts detector 1402 is for detecting an organ such as the eyes, nose and mouth making up the face as a face part from the face area extracted by the face area extraction unit 1401. The feature data extraction unit 1403 is for outputting by extracting the feature data constituting the information characterizing the face area from the face parts detected by the face parts detector 1402.

This process of the image recognition unit 1311 can be executed by any of the generally used methods including the method described in Kazuhiro Fukui and Osamu Yamaguchi, “Face Feature Point Extraction by Shape Extraction and Pattern Collation Combined,” The Institute of Electronics, Information and Communication Engineers Journal, Vol. J80-D-II, No. 8, pp. 2170-2177 (1997).

The translation decision unit 1304 determines whether the feature data output from the image recognition unit 1311 has changed or not, and upon determination that it has changed, determines the execution of translation with, as one unit, the recognition result stored in the source language storage unit 121 before the change of the face image information.

Specifically, in the case where the user directs his/her face toward the camera and the face image is recognized for the first time, the feature data characterizing the face area is output and thus the change in the face image information can be detected. Also, in the case where the expression of the user changes to a smiling face, for example, the feature data characterizing the smiling face is output and thus the change in the face image information can be detected. A change in face position can also be detected in similar fashion.

The translation decision unit 1304, upon detection of the change in the face image information as described above, determines the execution of the translation process with, as one unit, the recognition result stored in the source language storage unit 121 before the change in the face image information. Without regard to the linguistic information, therefore, the execution of translation or not can be determined by the nonlinguistic face information.

The translation decision rule storage unit 1322 is for storing the rule referred to by the translation decision unit 1304 to determine whether the recognition result is to be translated or not, and can be configured of any of the generally used storage media such as HDD, optical disk and memory card.

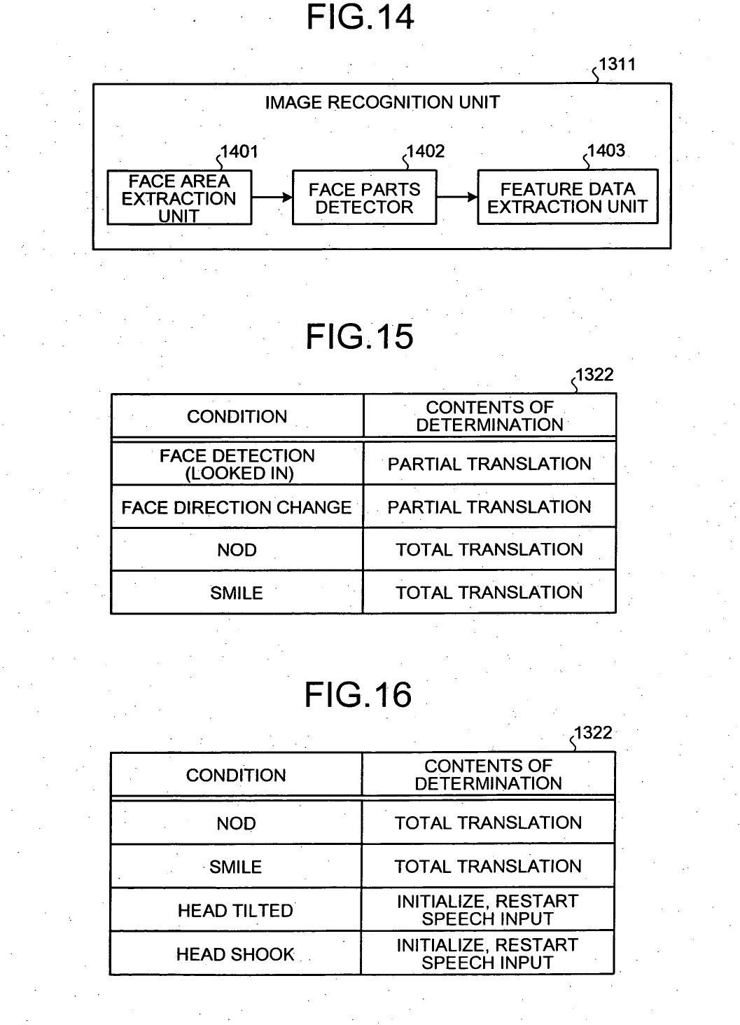

FIG. 15 is a diagram for explaining an example of the data structure of the translation decision rule storage unit 1322. As shown in FIG. 15, the translation decision rule storage unit 1322 has stored therein the conditions providing criteria and the contents of determination corresponding to the conditions.

In the case shown in FIG. 15, for example, the rule is defined that in the case where the user looks in his/her own device and the face image is detected, or in the case where the face position is changed, the partial translation is carried out. According to this rule, in the case where the screen is looked in to confirm the result of speech recognition during speech, the recognition result thus far input is subjected to partial translation.

Also, in the shown example, the rule is laid down that in the case where the user nods or the expression of the user changes to a smiling face, the total translation is carried out. This rule takes advantage of the fact that the user nods or smiles upon confirmation that the speech recognition result is correct.

When the user nods, it may be determined as a change in the face position, in which case the rule on the nod is given priority and the total translation is carried out.

FIG. 16 is a diagram for explaining another example of the data structure of the translation decision rule storage unit 1322. In the shown case, the translation decision rule is shown with a change of the face expression of the other party, not the user, as a condition.

When the other party of dialogue nods or the expression of the other party changes to a smiling face, like in the case of the user, the rule of total translation is applied. This rule takes advantage of the fact that as long as the other party of dialogue understands the synthesized speech sequentially spoken, he/she may nod or smile.

Also, the rule is set that in the case where the head of the other party is tilted or shook, no translation is carried out and all the past recognition result is deleted and the speech is input again. This rule utilizes the fact that the other party of dialogue nods or shakes his/her head as a denial because he/she cannot understand the synthesized speech sequentially spoken.

In this case, the storage control unit 109 issues a command for deletion from the translation decision unit 1304, so that all the source language and the translation stored in the source language storage unit 121 and the translation storage unit 123 are deleted.

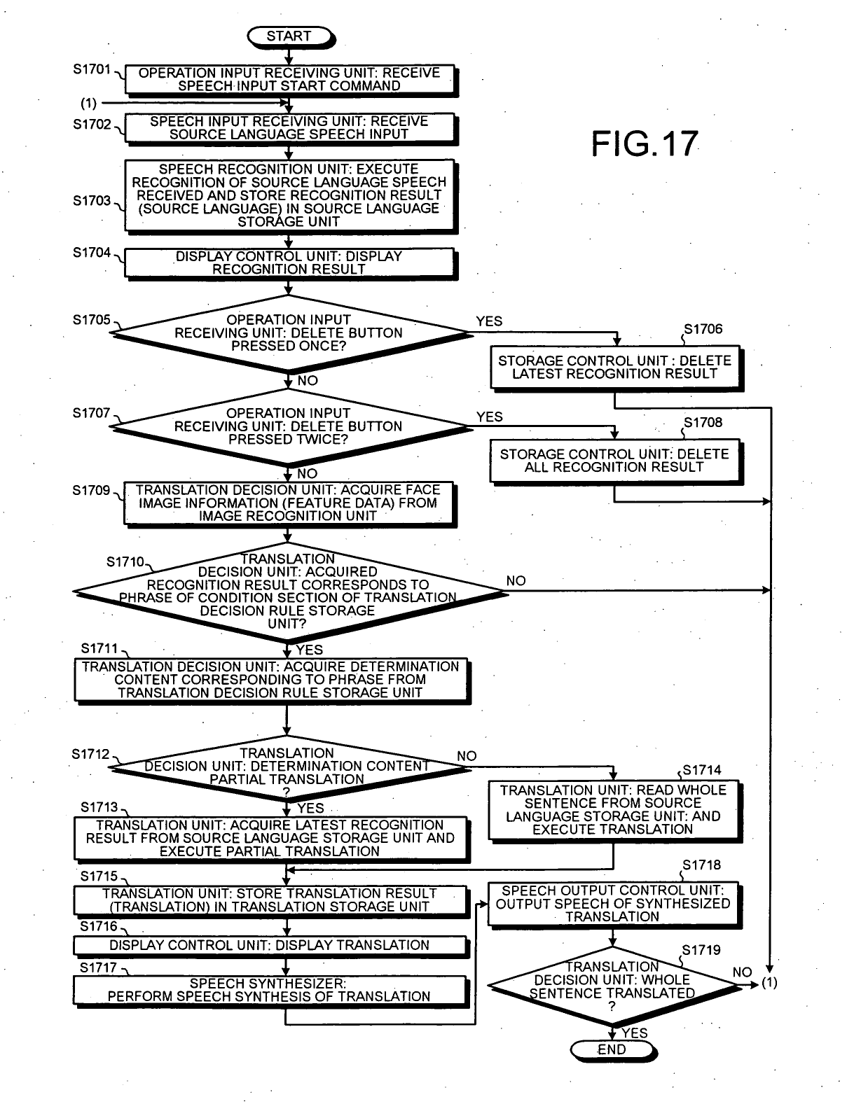

Next, the speech dialogue translation process executed by the speech dialogue translation apparatus 1300 according to the second embodiment having the above-mentioned configuration is explained. FIG. 17 is a flowchart showing the general flow of the speech dialogue translation process according to the second embodiment.

The speech input receiving process and the recognition result deletion process of steps S1701 to S1708 are similar to the process of steps S501 to S508 of the speech dialogue translation apparatus 100 according to the first embodiment, and therefore not explained again.

Upon determination at step S1707 that the delete button is not pressed twice successively (NO at step S1707), the translation decision unit 1304 acquires the feature data making up the face image information output by the image recognition unit 1311 (step S1709). Incidentally, the image recognition process is executed by the image recognition unit 1311 concurrently with the speech dialogue translation process. The image recognition process is described in detail later.

Next, the translation decision unit 1304 determines whether the conditions meeting the change in the face image information acquired are included in the conditions of the translation decision rule storage unit 1322 (step S1710). In the absence of a coincident condition (NO at step S1710), the process returns to the speech input receiving process to restart the whole process anew (step S1702).

In the presence of a coincident condition (YES at step S1710), on the other hand, the translation decision unit 1304 acquires the contents of determination corresponding to the particular condition from the translation decision rule storage unit 1322 (step S1711). Specifically, assume that the rule as shown in FIG. 15 is defined in the translation decision rule storage unit 1322. When the change in the face image information is detected to the effect that the face position of the user has changed, the “partial translation” making up the contents of determination corresponding to the condition “change in face position” is acquired.

The translation process, speech synthesis and output process of steps S1712 to S1719 are similar to the process of steps S514 to S521 of the speech dialogue translation apparatus 100 according to the first embodiment, and therefore not explained again.

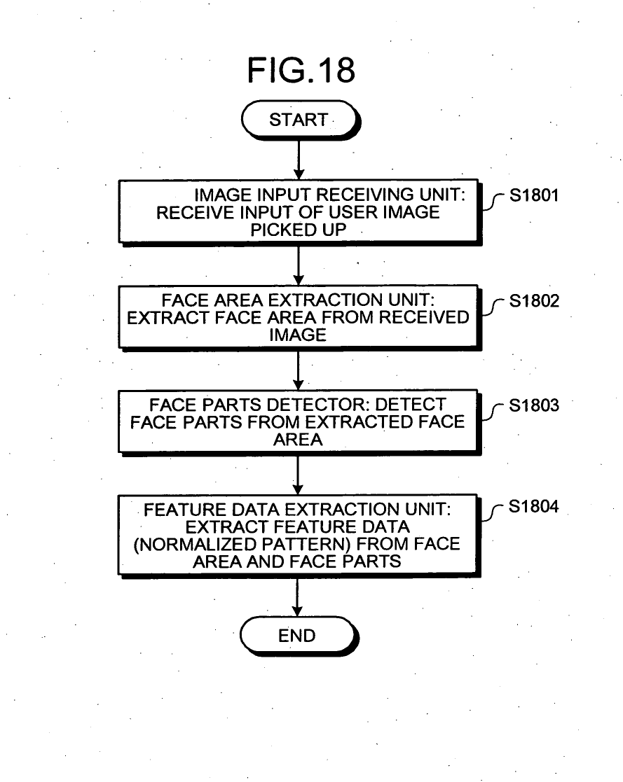

Next, the image recognition process executed concurrently with the speech dialogue translation process is explained in detail. FIG. 18 is a flowchart showing the general flow of the image recognition process according to the second embodiment.

First, the image input receiving unit 1310 receives the input of the image picked up by the image input unit such as a camera (step S1801). Then, the face area extraction unit 1401 extracts the face area from the image received (step S1802).

The face parts detector 1402 detects the face parts from the face area extracted by the face area extraction unit 1401 (step S1803). Finally, the feature data extraction unit 1403 outputs by extracting the normalized pattern providing the feature data from the face area extracted by the face area extraction unit 1401 and the face parts detected by the face parts detector 1402 (step S1804), and thus the image recognition process is ended.

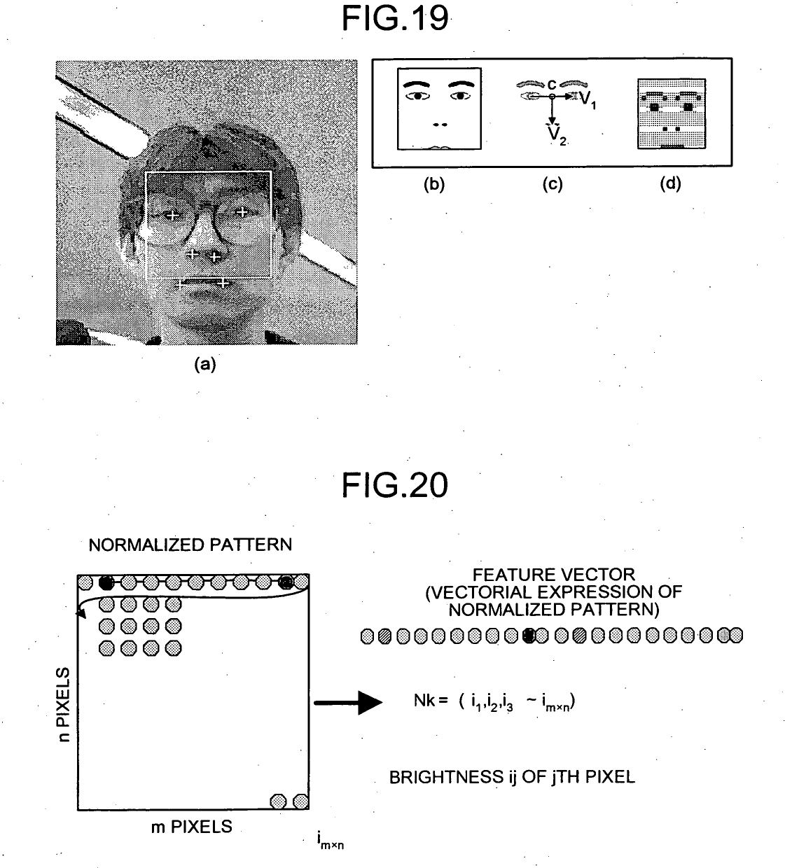

Next, a specific example of the image and the feature data processed in the image recognition process is explained. FIG. 19 is a diagram for explaining an example of the information processed in the image recognition process.

As shown in (a) of FIG. 19, a face area defined by a white rectangle is shown to be detected by pattern matching from the face image picked up from the user. Also, it is seen that the eyes, nostrils and mouth indicated by white crosses are detected.

A diagram schematically representing the face area and the face parts detected is shown in (b) of FIG. 19. As shown in (c) of FIG. 19, as long as the distance (say, V2) from the middle point C on the line segment connecting the right and left eyes to each part represents a predetermined ratio of the distance (V1) from right to left eyes, the face area is defined as the gradation matrix information of m pixels by n pixels as shown in (d) of FIG. 19. The feature data extraction unit 1403 extracts this gradation matrix information as a feature data. This gradation matrix information is also called the normalized pattern.

FIG. 20 is a diagram for explaining an example of the normalized pattern. The gradation matrix information of m pixels by n pixels similar to (d) of FIG. 19 is shown on the left side of FIG. 20. The right side of FIG. 20, on the other hand, shows an example of the feature vector expressing the normalized pattern in a vector.

In expressing the normalized pattern as a vector (Nk), assume that the brightness of the jth one of m×n pixels is defined as ij. Then, by arranging the brightness ij from the upper left pixel to the lower right pixel of the gradation matrix information, the vector Nk is expressed by Equation (1) below.
Nk=(i₁, i₂. i₃, . . . , i_{m×n}) (1)
When the normalized pattern extracted in this way coincides with a predetermined face image pattern, the detection of the face can be determined. The position (direction) and expression of the face are also detected by pattern matching.

In the example described above, the face image information is used to determine the motive of executing the translation by the translation unit 105. As an alternative, the face image information may be used to determine the motive of executing the speech synthesis by the speech synthesizer 107. Specifically, the speech synthesizer 107 is configured to execute the speech synthesis in accordance with the change in the face image by a similar method to the translation decision unit 1304. In the process, the translation decision unit 1304 can be configured, as in the first embodiment, to determine the execution of the translation with the phrase input time point as a motive.

Also, in place of executing the translation by detecting the change in the face image information, in the case where the silence period during which the user does not speak exceeds a predetermined time, the recognition result stored in the source language storage unit 121 before start of the silence period can be translated as one unit. As a result, the translation and the speech synthesis can be carried out by appropriately determining the end of the speech, while at the same time minimizing the silence period, thereby further promoting the smooth dialogue.

As described above, in the speech dialogue translation apparatus 1300 according to the second embodiment, upon determination that the face image information such as the face position or expression of the user or the other party changes, the recognition result is translated and the translation result is aurally synthesized and output. Therefore, a smooth dialogue correctly reflecting the psychological state of the user and the other party and the dialogue situation can be promoted.

Also, English can be aurally synthesized when the speech in Japanese is suspended and the face is directed toward the display screen, and therefore the likelihood of superposition between the Japanese speech and the synthesized English speech output is reduced, thereby making it possible to further promote a smooth dialogue.

In the speech dialogue translation apparatus according to the third embodiment, the information from an acceleration sensor for detecting the operation of the user's own device is accessed and upon determination that the operation of the device corresponds to a predetermined operation, the recognition result is translated and the translation, i.e. the translation result is aurally synthesized and output.

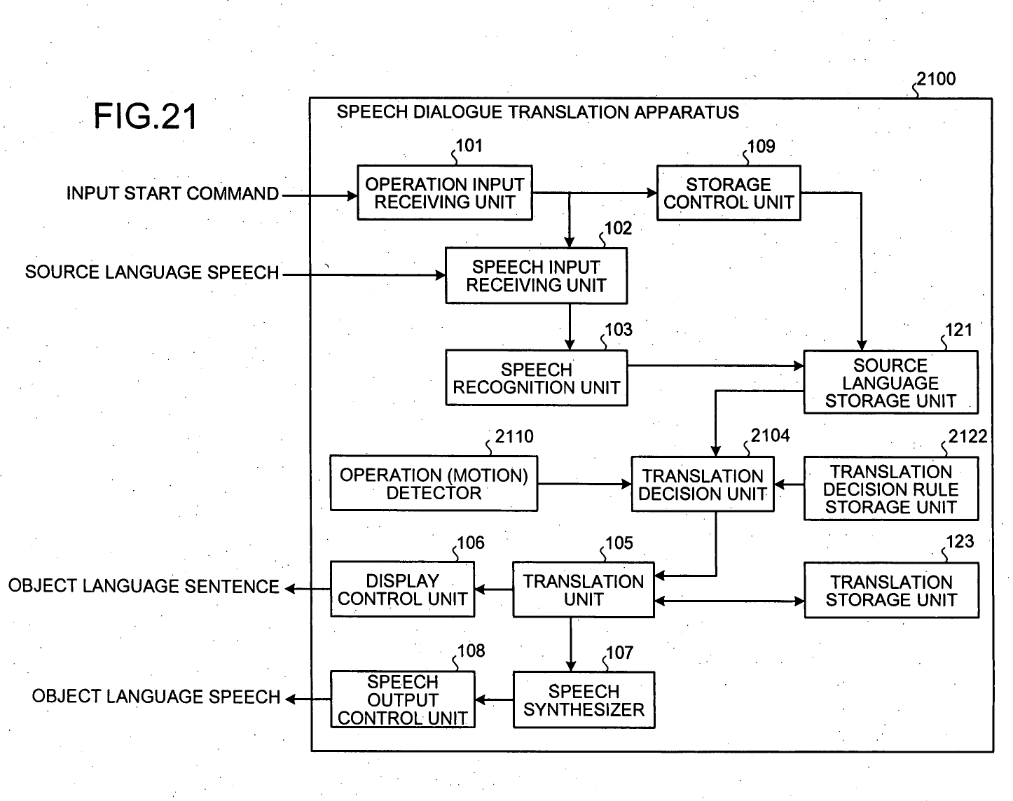

FIG. 21 is a block diagram showing a configuration of the speech dialogue translation apparatus 2100 according to the third embodiment. As shown in FIG. 21, the speech dialogue translation apparatus 2100 includes an operation input receiving unit 101, a speech input receiving unit 102, a speech recognition unit 103, a translation decision unit 2104, a translation unit 105, a display control unit 106, a speech synthesizer 107, a speech output control unit 108, a storage control unit 109, an operation detector 2110, a source language storage unit 121, a translation decision rule storage unit 2122 and a translation storage unit 123.

The third embodiment is different from the first embodiment in that the operation detector 2110 is added, the translation decision unit 2104 has a different function and the contents of the translation decision rule storage unit 2122 are different. The other component parts of the configuration and functions, which are similar to those of the speech dialogue translation apparatus 100 according to the first embodiment shown in the block diagram of FIG. 1, are designated by the same reference numerals, respectively, and not described any more.

The operation detector 2110 is an acceleration sensor or the like for detecting the operation of the own device. In recent years, the portable terminal with the acceleration sensor has been available on the market, and therefore such a sensor attached to the portable terminal may be used as the operation detector 2110.

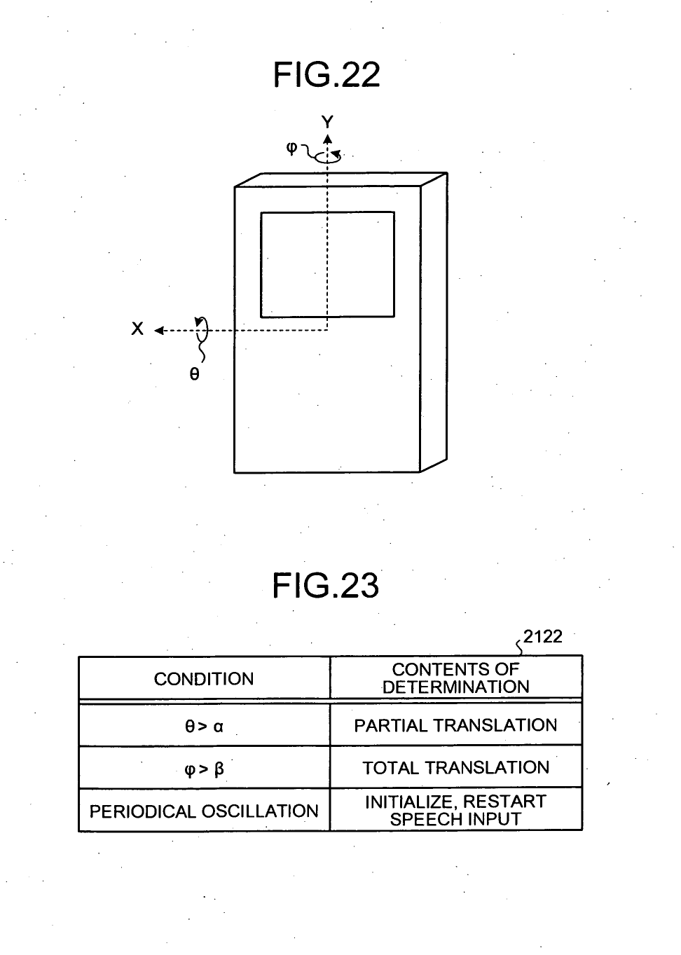

FIG. 22 is a diagram for explaining an example of operation detected by the acceleration sensor. An example using a two-axis acceleration sensor is shown in FIG. 22. The rotational angles θ and φ around X and Y axes, respectively, can be measured by this sensor. Nevertheless, the operation detector 2110 is not limited to the two-axis acceleration sensor but any detector such as a three-axis acceleration sensor can be used as long as the operation of the own device can be detected.

The translation decision unit 2104 is for determining whether the operation of the own device detected by the operation detector 2110 corresponds to a predetermined operation or not. Specifically, it determines whether the rotational angle in a specified direction has exceeded a predetermined value or not, or the operation corresponds to a periodic oscillation of a predetermined period or not.

The translation decision unit 2104, upon determination that the operation of the own device corresponds to a predetermined operation, determines the execution of the translation process with, as one unit, the recognition result stored in the source language storage unit 121 before the determination of correspondence to a predetermined operation. As a result, determination as to whether translation is to be carried out is possible based on the nonlinguistic information including the device operation without the linguistic information.

The translation decision rule storage unit 2122 is for storing the rule referred to by the translation decision unit 2104 to determine whether the recognition result is to be translated or not, and can be configured of any of the generally used storage media such as HDD, optical disk and memory card.

FIG. 23 is a diagram for explaining an example of the data structure of the translation decision rule storage unit 2122. As shown in FIG. 23, the translation decision rule storage unit 2122 has stored therein the conditions providing criteria and the contents of determination corresponding to the conditions.

In the shown case, the rule is defined to carry out the partial translation in the case where the user rotates the own device around X axis to a position at which the display screen of the own device is visible and the rotational angle θ exceeds a predetermined threshold value α. This rule is set to assure partial translation of the recognition result input before the time point at which the own device is tilted toward the line of eyesight to confirm the result of speech recognition during speech.

Also, in the shown case, the rule is defined to carry out the total translation in the case where the display screen of the own device is rotated around Y axis to a position at which the display screen is visible by the other party and the rotational angle φ exceeds a predetermined threshold value β. This rule is set to assure total translation of all the recognition result in view of the fact that the user operation of directing the display screen toward the other party of dialogue confirms that the speech recognition result is correct.

Further, the rule may be defined that in the case where the speech recognition is not correctly carried out and the user periodically shakes the own device horizontally, restarts from the first input operation, no translation is conducted and the entire past recognition result is deleted to repeat the speech input from the beginning. The rule conditional on the behavior is not limited to the aforementioned cases, and any rule can be defined to specify the contents of the translation process in accordance with the motion of the own device.

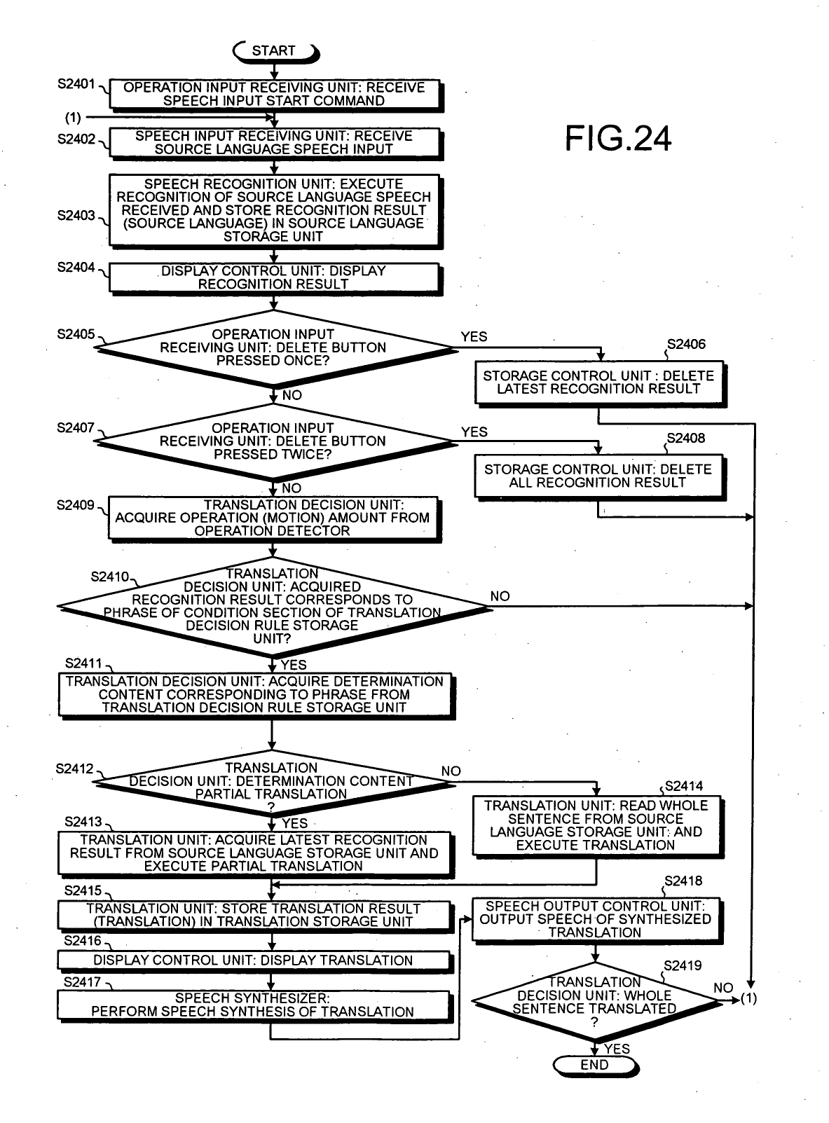

Next, the speech dialogue translation process executed by the speech dialogue translation apparatus 2100 according to the third embodiment having the configuration described above is explained. FIG. 24 is a flowchart showing the general flow of the speech dialogue translation process according to the third embodiment.

The speech input receiving process and the recognition result deletion process of steps S2401 to S2408 are similar to the process of steps. S501 to S508 of the speech dialogue translation apparatus 100 according to the first embodiment, and therefore not explained again.

Upon determination at step S2407 that the delete button is not pressed twice successively (NO at step S2407), the translation decision unit 2104 acquires the operation amount output from the operation detector 2110 (step S2409). Incidentally, the operation detection process by the operation detector 2110 is executed concurrently with the speech dialogue translation process.

Next, the translation decision unit 2104 determines whether the operation amount acquired satisfies the conditions of the translation decision rule storage unit 2122 (step S2410). In the absence of a coincident condition (NO at step S2410), the process returns to the speech input receiving process to restart the whole process anew (step S2402).

In the presence of a coincident condition (YES at step S2410), on the other hand, the translation decision unit 2104 acquires the contents of determination corresponding to the particular condition from the translation decision rule storage unit 2122 (step S2411). Specifically, assume that the rule as shown in FIG. 23 is defined in the translation decision rule storage unit 2122. When the user rotates the device around X axis to confirm the speech recognition result and the rotational angle θ exceeds a predetermined threshold value α, for example, the “partial translation” constituting the contents of determination corresponding to the condition θ>α is acquired.

The translation process, speech synthesis and output process of steps S2412 to S2419 are similar to the process of steps S514 to S521 of the speech dialogue translation apparatus 100 according to the first embodiment, and therefore not explained again.

In the example described above, the operation amount detected by the operation detector 2110 is utilized to determine the motive of executing the translation by the translation unit 105. As an alternative, the operation amount can be used to determine the motive of executing the speech synthesis by the speech synthesizer 107. Specifically, the speech synthesis is executed by the speech synthesizer 107 after determination whether the detected operation corresponds to a predetermined operation or not according to a similar method to the translation decision unit 2104. In the process, the translation decision unit 2104 may be configured to determine, as in the first embodiment, the execution of translation with the phrase input as a motive.

As described above, in the speech dialogue translation apparatus 2100 according to the third embodiment, upon determination that the motion of the own device corresponds to a predetermined motion, the recognition result is translated and the translation result is aurally synthesized and output. Therefore, the smooth dialogue reflecting the natural behavior or gesture of the user during the dialogue can be promoted.

Incidentally, the speech dialogue translation program executed by the speech dialogue translation apparatus according to the first to third embodiments is available in a form built in a ROM (read-only memory) or the like.

The speech dialogue translation program executed by the speech dialogue translation apparatus according to the first to third embodiments may be configured as an installable or executable file recorded in a computer-readable recording medium such as a CD-ROM (compact disk read-only memory), flexible disk (FD), CD-R (compact disk recordable), DVD (digital versatile disk), etc.

Further, the speech dialogue translation program executed by the speech dialogue translation apparatus according to the first to third embodiments can be so configured as to be stored in a computer connected to a network such as the internet and adapted to be downloaded through the network. Also, the speech dialogue translation program executed by the speech dialogue translation apparatus according to the first to third embodiments can be so configured as to be provided or distributed through a network such as the Internet.

The speech dialogue translation program executed by the speech dialogue translation apparatus according to the first to third embodiments is configured of modules including the various parts described above (operation input receiving unit, speech input receiving unit, speech recognition unit, translation decision unit, translation unit, display control unit, speech synthesizer, speech output control unit, storage control unit, image input receiving unit and image recognition unit). As an actual hardware, a CPU (central processing unit) executes by reading the speech dialogue translation program from the ROM, so that the various parts described above are loaded onto and generated on the main storage unit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A speech dialogue translation apparatus comprising:
a speech recognition unit that recognizes a user's speech in a source language to be translated and outputs a recognition result;
a source language storage unit that stores the recognition result;
a translation decision unit that determines whether the recognition result stored in the source language storage unit is to be translated, based on a rule defining whether a part of an ongoing speech is to be translated;
a translation unit that converts the recognition result into a translation described in an object language and outputs the translation, upon determination that the recognition result is to be translated; and
a speech synthesizer that synthesizes the translation into a speech in the object language.

2. The speech dialogue translation apparatus according to claim 1,
wherein the translation decision unit determines whether the recognition result in a predetermined language unit constituting a sentence is output, and upon determination that the recognition result of the language unit is output, determines that the recognition result in the language unit is translated as one unit.

3. The speech dialogue translation apparatus according to claim 1,
wherein the translation decision unit determines whether a silence period of the user has exceeded a predetermined time length, and upon determination that the silence period has exceeded the predetermined time length, determines that the recognition result stored in the source language storage unit before a start of the silence period is translated as one unit.

4. The speech dialogue translation apparatus according to claim 1, further comprising an operation input receiving unit that receives a command to end the speech from the user,
wherein the translation decision unit, upon receipt of the end of the speech of the user by the operation input receiving unit, determines that the recognition result stored in the source language storage unit from start to end of the speech is translated as one unit.

5. The speech dialogue translation apparatus according to claim 1, further comprising:
a display unit that displays the recognition result;
an operation input receiving unit that receives a command to delete the recognition result displayed; and
a storage control unit that deletes, upon receipt of a deletion command by the operation input receiving unit, the recognition result from the source language storage unit in response to the deletion command.

6. The speech dialogue translation apparatus according to claim 1, further comprising:
an image input receiving unit that receives a face image of one of the user and other party of dialogue picked up by an image pickup unit; and
an image recognition unit that recognizes the face image and acquires face image information including a direction of the face and an expression of the one of the user and the other party,
wherein the translation decision unit determines whether the face image information has changed, and upon determination that the face image information has changed, determines that the recognition result stored in the source language storage unit before a change in the face image information is translated as one unit.

7. The speech dialogue translation apparatus according to claim 6,
wherein the speech synthesizer determines whether the face image information has changed, and upon determination that the face image information has changed, synthesizes the translation into a speech in the object language.

8. The speech dialogue translation apparatus according to claim 6,
wherein the translation decision unit determines whether the face image information has changed, and upon determination that the face image information has changed, determines that the recognition result is deleted from the source language storage unit,
the apparatus further comprising a storage control unit that deletes the recognition result from the source language storage unit upon determination by the translation decision unit that the recognition result is to be deleted from the source language storage unit.

9. The speech dialogue translation apparatus according to claim 1, further comprising a motion detector that detects an operation of the speech dialogue translation apparatus,
wherein the translation decision unit determines whether the operation corresponds to a predetermined operation, and upon determination that the operation corresponds to the predetermined operation, determines that the recognition result stored in the source language storage unit before the predetermined operation is translated as one unit.

10. The speech dialogue translation apparatus according to claim 9,
wherein the speech synthesizer determines whether the operation corresponds to a predetermined operation, and upon determination that the operation corresponds to the predetermined operation, synthesizes the translation into a speech in the object language.

11. The speech dialogue translation apparatus according to claim 9,
wherein the translation decision unit determines whether the operation corresponds to a predetermined operation, and upon determination that the operation corresponds to the predetermined operation, determines that the recognition result is deleted from the source language storage unit,
the apparatus further comprising a storage control unit that deletes the recognition result from the source language storage unit upon determination by the translation decision unit that the recognition result is to be deleted from the source language storage unit.

12. A speech dialogue translation method, comprising:
recognizing a user's speech in a source language to be translated;
outputting a recognition result;
determining whether the recognition result stored in a source language storage unit is to be translated, based on a rule defining whether a part of an ongoing speech is to be translated;
converting the recognition result into a translation described in an object language and outputs the translation, upon determination that the recognition result is to be translated; and
synthesizing the translation into a speech in the object language.

13. A computer program product having a computer readable medium including programmed instructions, wherein the instructions, when executed by a computer, cause the computer to perform:
recognizing a user's speech in a source language to be translated;
outputting a recognition result;
determining whether the recognition result stored in a source language storage unit is to be translated, based on a rule defining whether a part of an ongoing speech is to be translated;
converting the recognition result into a translation described in an object language and outputs the translation, upon determination that the recognition result is to be translated; and
synthesizing the translation into a speech in the object language.
